(19) United States
(12) Patent Application Publication
(10) Pub. No.: US 2007/0258009 A1
(43) Pub. Date: Nov. 8, 2007

(54) Image Processing Device, Image Processing Method, and Image Processing Program

(75) Inventors: Jun Kanda, Saitama (JP); Hiroshi Iwamura, Saitama (JP); Hiroshi Yamazaki, Saitama (JP)

Correspondence Address: FOLEY AND LARDNER LLP;SUITE 500, 3000 K STREET NW, WASHINGTON, DC, 20007, US

(73) Assignee: PIONEER CORPORATION

(21) Appl. No.: 11/664,056

(22) PCT Filed: Sep. 29, 2005
(86) PCT No.: PCT/JP05/17976

§ 371 Date: May 24, 2007

(30) Foreign Application Priority Data
Sep. 30, 2004 (JP) 2004-287468

(51) Int. Cl. H04N 7/26

(52) U.S. Cl. 348/416.1

(57) ABSTRACT

Plural shots in a picture are classified into plural groups based on a similarity between the shots, and further, the shots particularly similar to each other in the group are linked to each other, to be hierarchically arranged, as shown in the drawings. For example, in a group A in the drawings, a representative frame “K_{A1}” in a shot “A1” is intra-encoded, and then, all of respective representative frames “S_{A21}”, “S_{A22}”, and “S_{A23}” in shots “A21”, “A22”, and “A23” in one lower hierarchy are subjected to prediction encoding using the frame “K_{A1}”. In the same manner, representative frames in the shots are subjected to the prediction encoding using a representative frame in one upper hierarchy in the same group in a daisy-chain manner. Frames other than the representative frames are subjected to the prediction encoding using a representative frame to which the frame belongs.

### TECHNICAL FIELD

The present invention relates to an image processing device that encodes or decodes a moving image, an image processing method, and an image processing program. The application of the present invention is not limited to the image processing device, the image processing method, and the image processing program.

### BACKGROUND ART

For various purposes of enhancement of encoding efficiency in encoding a moving image, versatility of an access to a moving image, facilitation of browsing of a moving image, and easiness of conversion of a file format, the inventions according to conventional techniques for structuring a moving image (specifically, rearranging the order of frames, hierarchizing a moving image per shot, and the like) are disclosed in Patent Documents 1 to 5 below.

In a conventional technique disclosed in Patent Document 1, a file creating unit creates edition information representing a rearranging order of moving image data per frame. Furthermore, an image compressing unit compresses and encodes the moving image data before edition according to a difference between frames, and then, an output unit transmits the encoded data together with a file of the edition information.

Moreover, in a conventional technique disclosed in Patent Document 2, prediction encoded image data stored in an image-data-stream memory unit is read, to be thus separated into hierarchies by a hierarchy separating unit according to a hierarchy of a data structure. Next, an image property-extracting unit extracts physical properties, that is, properties that have generality and reflect contents, from the separated hierarchy. Thereafter, a feature vector-producing unit produces a feature vector that features each of images according to the physical properties. Subsequently, a splitting/integrating unit calculates a distance between the feature vectors, and then, splits/integrates the feature vector, so as to automatically structure a picture in a deep hierarchy structure, so that a feature-vector managing unit stores and manages the feature vector.

Alternatively, a conventional technique disclosed in Patent Document 3 is directed to an automatic hierarchy-structuring method, in which a moving image is encoded, the encoded moving image is split into shots, and then, a scene is extracted by integrating the shots using a similarity of each of the split shots. Moreover, the conventional technique disclosed in Patent Document 3 is also directed to a moving-image browsing method, in which the contents of all of the moving images are grasped using the hierarchy structured data and a desired scene or shot is readily detected.

Furthermore, in a conventional technique disclosed in Patent Document 4, a switching unit sequentially switches video signals on plural channels, picked up by plural cameras, a rearranging unit rearranges the video signals in a unit of a GOP per channel, an MPEG compressing unit compresses the video signals to record in a recording unit, and further, an MPEG expanding unit expands the video signals per channel, thus compressing a data size so as to store and reproduce the picture data in the input order of each of the channels in total at a predetermined position of plural displaying memories such that a display control unit displays picture data on multiple screens, whereby an image output unit displays the multiple screens on one screen of a monitor.

Moreover, in a conventional technique disclosed in Patent Document 5, a size converting unit converts a reproduced moving-image signal A2 obtained by decoding, by an MPEG-2 decoder, a bit stream A1 in an MPEG-2 format which is a first moving-image encoding-data format and side information A3 into a format suitable for an MPEG-4 format which is a second moving image encoding data format. Then, a bit stream A6 in an MPEG-4 format is obtained by encoding, by an MPEG-4 encoder, a converted reproduced image-signal A4 using motion vector information included in converted side information A5. At the same time, an indexing unit performs indexing using a motion vector included in the side information A5, and structured data A7 is obtained.

Patent Document 1: Japanese Patent Application Laid-open No. H8-186789

Patent Document 2: Japanese Patent Application Laid-open No. H9-294277

Patent Document 3: Japanese Patent Application Laid-open No. H10-257436

Patent Document 4: Japanese Patent Application Laid-open No. 2001-054106

Patent Document 5: Japanese Patent Application Laid-open No. 2002-185969

### DISCLOSURE OF INVENTION

### Problem to be Solved by the Invention

In the meantime, various prediction systems are conventionally proposed for the purpose of enhancement of encoding efficiency in encoding a moving image. For example, the encoding efficiency is enhanced by adopting a forward prediction frame (i.e., a P frame) or a bidirectional prediction frame (i.e., a B frame) in MPEG-1, adopting a field prediction in MPEG-2, adopting sprite encoding or a global motion compensation (GMC) prediction in MPEG-4 part_2, and adopting plural reference frames in ITU-TH, 264/MPEG-4 part_10 (advanced video coding (AVC)).

A picture to be encoded normally includes numerous shots (plural sequential frames) similar to each other, as listed below:
a breast shot to a news caster in a news program;
a pitching/batting scene in a baseball game, a serving scene in a tennis game, a going downhill/flying scene in a ski jump game, and the like;
repetition of a highlight scene in a sports program;
repetition of the same shot before and after a commercial message in a variety program;
an up shot to each of two persons in the case of alternately repetitive up shots in a dialogue scene between the two persons;
an opening scene, an ending scene or a reviewing scene of the last story throughout all stories of a serialized drama, and the like; and
repetition of the same commercial message.

Without mentioning the repetition of the same shot, shots at the same angle by a fixed camera often result in similar shots. These similar shots can be expected to be more reduced in encoding amount as a whole by encoding a difference between the shots by regarding one shot as a reference frame of the other shot than by independently encoding the similar shots.

However, in the conventional MPEG, the structure of the entire target picture, for example, the repetition of the similar shots is not utilized for encoding (in other words, the redundancy of information amount between the similar shots is not utilized), but the shots are normally encoded in a time series order, thereby raising a problem of low encoding efficiency accordingly. Specifically, prediction methods by the conventional techniques in the case of a scene change in a picture include procedures (1) to (3), as follows.

(1) Insertion of I Frame at Predetermined Interval (see FIG. 15(1))

I frames are inserted at predetermined intervals irrespective of a scene change. In this case, many inter-frames immediately after the scene change (specifically, P frames thereamong) are produced (due to a large prediction error). In addition, many inter-frames cannot be produced, thereby degrading the quality of an image.

(2) Insertion of I Frame Also at Time of Scene Change (see FIG. 15(2))

Although the I frames are basically inserted at the predetermined intervals, the I frame is inserted also at a timing upon detection of the scene change. In this case, the quality of an image is improved, but many I frames are produced while the distribution of other inter-frames is reduced accordingly, thereby totally degrading the quality of an image.
(3) Selection of Reference Frame from Plural Candidates

This is a system to be adopted in H.264 (MPEG-4 part_10 AVC). In the case of H.264, the number of frames to be selected as the reference frame has an upper limit. Furthermore, the reference frame need be present in a predetermined distance from a frame to be encoded.

### MEANS FOR SOLVING PROBLEM

To solve the above problems and achieve an object, an image processing device according to claim 1 includes a shot splitting unit that splits a moving image into plural shots including plural sequential images; a shot structuring unit that structures the shots split by the shot splitting unit based on a similarity between the shots; a motion-detecting unit that detects motion information between an image to be encoded included in the moving image and a reference image specified based on a structuring result of the shot-structuring unit; a motion compensating unit that generates a prediction image of the image to be encoded from the reference image based on the motion information detected by the motion detecting unit; and an encoding unit that encodes a difference between the image to be encoded and the prediction image generated by the motion-compensating unit.

Moreover, an image processing device according to claim 4 includes a structured-information extracting unit that extracts information on a structure of a moving image from an encoded stream of the moving image; a first decoding unit that decodes an image, to which another image refers, out of images in the encoded stream based on the information extracted by the structured-information extracting unit; and a second decoding unit that decodes an image to be decoded in the encoded stream using a reference image designated among the information extracted by the structured-information extracting unit and decoded by the first decoding unit.

Moreover, an image processing method according to claim 6 includes a shot splitting step of splitting a moving image into plural shots including plural sequential images; a shot structuring step of structuring the shots split at the shot splitting step based on a similarity between the shots; a motion detecting step of detecting motion information between an image to be encoded included in the moving image and a reference image specified based on a structuring result at the shot structuring step; a motion compensating step of generating a prediction image of the image to be encoded from the reference image based on the motion information detected at the motion detecting step; and an encoding step of encoding a difference between the image to be encoded and the prediction image generated at the motion compensating step.

Moreover, an image processing method according to claim 9 includes a structured-information extracting step of extracting information on a structure of a moving image from an encoded stream of the moving image; a first decoding step of decoding an image, to which another image refers, out of images in the encoded stream based on the information extracted at the structured-information extracting step; and a second decoding step of decoding an image to be decoded in the encoded stream using a reference image designated among the information extracted at the structured-information extracting step and decoded at the first decoding step.

Moreover, an image processing program according to claim 11 causes a processor to execute a shot splitting step of splitting a moving image into plural shots including plural sequential images; a shot structuring step of structuring the shots split at the shot splitting step based on a similarity between the shots; a motion detecting step of detecting motion information between an image to be encoded included in the moving image and a reference image specified based on a structuring result at the shot structuring step; a motion compensating step of generating a prediction image of the image to be encoded from the reference image based on the motion information detected at the motion detecting step; and an encoding step of encoding a difference between the image to be encoded and the prediction image generated at the motion compensating step.

Moreover, an image processing program according to claim 14 causes a processor to execute a structured-information extracting step of extracting information on a structure of a moving image from an encoded stream of the moving image; a first decoding step of decoding an image, to which another image refers, out of images in the encoded stream based on the information extracted at the structured-information extracting step; and a second decoding step of decoding an image to be decoded in the encoded stream using a reference image designated among the information extracted at the structured-information extracting step of extracting and decoded at the first decoding step.

### BRIEF DESCRIPTION OF DRAWINGS

FIG. 1 is an explanatory diagram of one example of the configuration of an image processing device (i.e., an encoder) according to an embodiment of the present invention;

FIG. 2 is an explanatory diagram for schematically illustrating feature amount of each of shots, which is a basis of a feature amount vector;

FIG. 3 is an explanatory diagram for schematically illustrating a shot structured by a shot structuring unit 112;

FIG. 4 is an explanatory diagram of one example of an arrangement order in a picture of shots structured as shown in FIG. 3;

FIG. 5 is an explanatory diagram of another example of the arrangement order in the picture of shots structured as shown in FIG. 3;

FIG. 6 is an explanatory diagram for schematically illustrating a shot structured by a shot structuring unit 112 (when a head frame of each of the shots is regarded as a representative frame);

FIG. 7 is a flowchart of image encoding processing procedures in the image processing device according to the embodiment of the present invention;

FIG. 8 is a flowchart of the details of a shot structuring procedure (step S702 in FIG. 7) by the shot-structuring unit 112;

FIG. 9 is an explanatory diagram for schematically illustrating the concept of a global motion compensation prediction;

FIG. 10 is an explanatory diagram for schematically illustrating the concept of a motion compensation prediction per block;

FIG. 11 is an explanatory diagram of one example of an arrangement order in a picture of shots structured as shown in FIG. 12;

FIG. 12 is an explanatory diagram for schematically illustrating the shot structured by the shot structuring unit 112 (in the case of no hierarchy among shots inside of a group);

FIG. 13 is an explanatory diagram of one example of the configuration of an image processing device (i.e., a decoder) according to an embodiment of the present invention;

FIG. 14 is a flowchart of image decoding processing procedures in the image processing device according to the embodiment of the present invention; and

FIG. 15 is an explanatory diagram for schematically illustrating timing when I frames are inserted by conventional techniques.

### EXPLANATIONS OF LETTERS OR NUMERALS

100, 1300 input buffer memory
101 transforming unit
102 quantizing unit
103, 1301 entropy encoding unit
104 encoding control unit
105, 1302 inverse quantizing unit
106, 1303 inverse transforming unit
107 locally-decoded-image storage memory
108 motion-vector detecting unit
109, 1304 inter-frame-motion compensating unit
110 multiplexing unit
111 shot splitting unit
112 shot structuring unit
113, 1306 reference-frame storage memory
1305 structured-information extracting unit

### BEST MODE(S) FOR CARRYING OUT THE INVENTION

An image processing device, an image processing method, and an image processing program will be explained below in details in exemplary embodiments according to the present invention in reference to the attached drawings.

### Embodiment

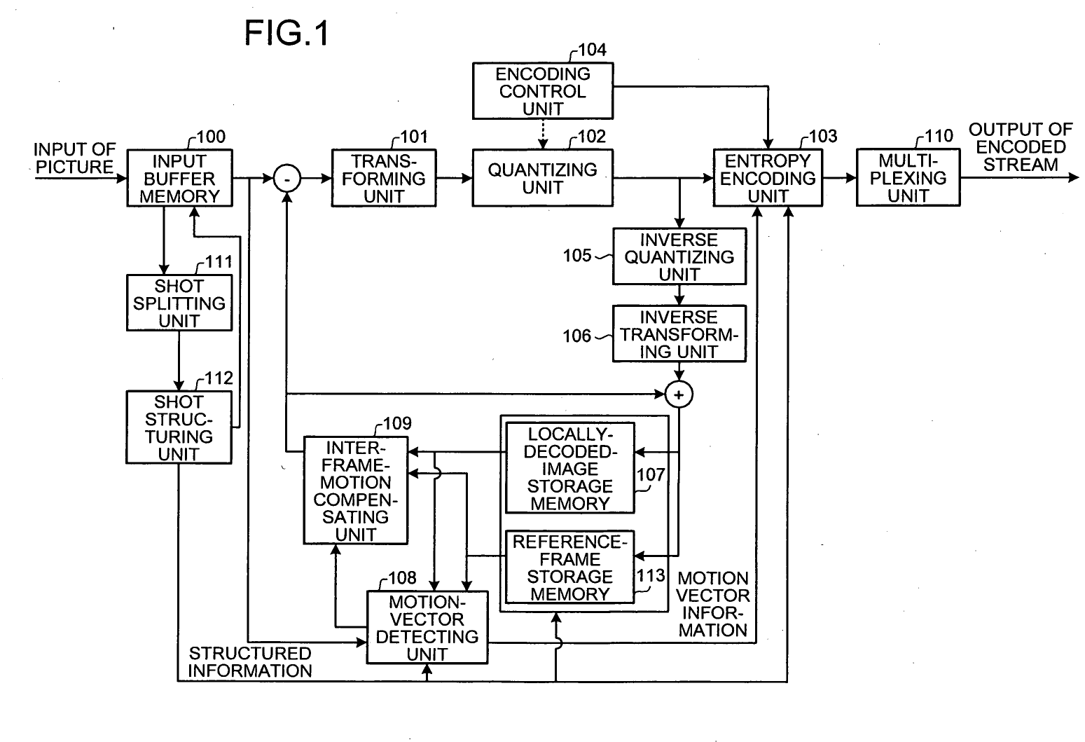

FIG. 1 is an explanatory diagram of one example of the configuration of an image processing device (i.e., an encoder) according to an embodiment of the present invention. In FIG. 1, constituent elements 100 to 110 are identical to those in a JPEG/MPEG encoder by a conventional technique. Specifically, reference numeral 100 designates an input buffer memory that holds each of frames of a picture to be encoded; reference numeral 101 denotes a transforming unit that performs a discrete cosine transform (DCT) or a discrete wavelet transform (DWT) on (a prediction error obtained by subtracting a reference frame from) a frame to be encoded; reference numeral 102 designates a quantizing unit that quantizes the data after the transformation in a predetermined step width; reference numeral 103 denotes an entropy encoding unit that encodes the data after the quantization, or motion vector information, structured information or the like, described later, (irrespective of technique, in particular); and reference numeral 104 designates an encoding control unit that controls the operations of the quantizing unit 102 and the entropy encoding unit 103.

Furthermore, reference numeral 105 designates an inverse quantizing unit that inverse quantizes data after the quantization before encoding; reference numeral 106 denotes an inverse transforming unit that further inverse transforms data after the inverse quantization; and reference numeral 107 designates a locally-decoded-image storage memory that temporarily holds the reference frame in addition to a frame after the reverse transformation, that is, a locally decoded image.

Moreover, reference numeral 108 designates a motion vector detecting unit that calculates motion information between the frame to be encoded and the reference frame, specifically here, a motion vector; reference numeral 109 denotes an inter-frame-motion compensating unit that produces a prediction value (i.e., a frame) of the frame to be encoded based on the reference frame according to the calculated motion vector. Additionally, reference numeral 110 designates a multiplexing unit that multiplexes the encoded picture, the motion vector information, structured information, described later, or the like. Here, the pieces of information may not be multiplexed but transmitted as independent streams (the need of multiplexing depends upon an application).

Next, each of constituent elements 111 to 113 which are features according to the present invention will be explained below. First of all, reference numeral 111 denotes a shot splitting unit serving as a functional unit that splits the picture stored in the input buffer memory 100 into plural sequential frames, that is, “shots”. A split point of the shots is exemplified by a change point of image feature amount in the picture or a change point of feature amount of a background sound. Among them, the change point of image feature amount may be exemplified by a switch point of a screen (i.e., a scene change or a cut point) or a change point of camera work (such as a scene change, a pan, a zoom or a stop). Here, the present invention places no particular importance on where the split point is located or how the split point is specified (in other words, how the shot is constituted).

Reference numeral 112 designates a shot-structuring unit serving as a functional unit that structures the shots split by the shot splitting unit 111 according to a similarity between the shots. Although the present invention places no particular importance on how the similarity between the shots is calculated, a feature amount vector X of each of the shots, for example, is obtained, and then, a Euclidean distance between the feature amount vectors is regarded as the similarity between the shots.

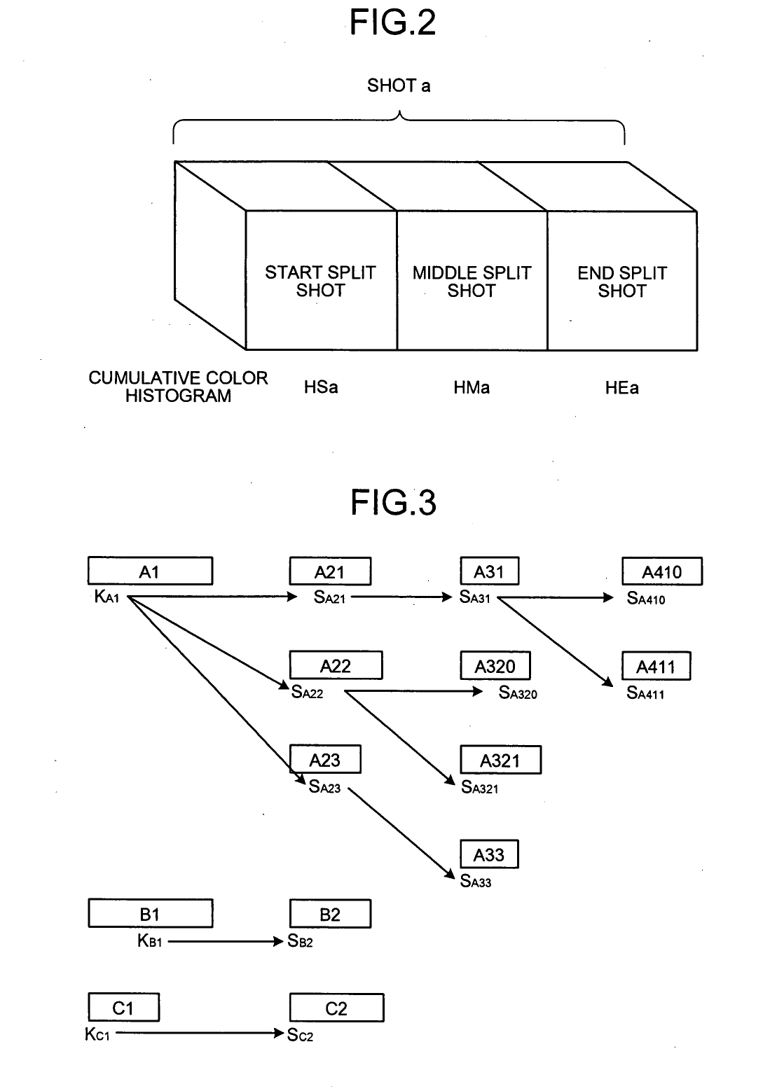

For example, a feature amount vector Xa of shot a is a multi-dimensional vector consisting of cumulative color histograms of partial shots obtained by splitting shot a into N shots. As shown in FIG. 2, when N is 3,
Xa={HSa,HMa,HEa},
where HSa signifies a cumulative color histogram of “a start split shot” in FIG. 2;

HMa signifies a cumulative color histogram of “a middle split shot” in FIG. 2; and

HEa signifies a cumulative color histogram of “an end split shot” in FIG. 2.

Here, HSa, HMa, and HEa per se are multi-dimensional feature-amount vectors.

“The color histogram” signifies a count of appearance times in each of plural regions obtained by splitting a color space with respect to all pixels inside of the frame. As the color space are utilized, for example, RGB (R/red, G/green, and B/blue), a CbCr component out of YCbCr (Y/luminance and CbCr/color difference), and a Hue component out of HSV (H/hue, S/saturation, and V/value). Images different in size can be compared with each other by normalizing the obtained histogram using the number of pixels inside of the frame. “The cumulative color histogram” is obtained by cumulating the normalized histogram with respect to all of the frames inside of the shot.

Subsequently, a similarity D_{a,b} between shot a and another shot b is calculated using the feature amount vectors obtained as described above, according to, for example, the following equation:
D_{a,b}=∥Xₐ−X_{b}∥ [Equation 1]
As the shot has a smaller value D_{a,b} (i.e., a distance between the feature vectors is smaller), the similarity is higher, and the shot has a greater value D_{a,b} (i.e., a distance between the feature vectors is greater), the similarity is lower. The shot structuring unit 112 classifies and hierarchizes the shots according to the similarity, as shown in FIG. 3.

In FIG. 3, individual rectangles designated by “A1”, “B1” and the like show shots. As shown in FIG. 3, the shots split by the shot splitting unit 111 are classified into a group having a similarity equal to or lower than a threshold (three groups A, B, and C in an example shown in FIG. 3). In each of the groups, the shots particularly similar to each other are connected via arrows.

Specifically, out of, for example, ten shots in the group A, three shots “A21”, “A22”, and “A23” particularly have a highest similarity to the shot “A1”; a shot “A31” particularly has a highest similarity to the shot “A21”; and two shots “A410” and “A411” particularly have a highest similarity to the shot “A31”.

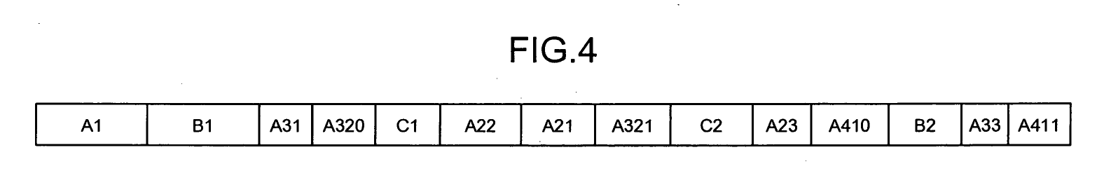

Incidentally, the arrangement order of the shots inside of the original picture is assumed as shown in, for example, FIG. 4. Although the shot “A21” is located before the shot “A31” in FIG. 3, the shot “A21” is a shot later than the shot “A31” in time series in FIG. 4. Additionally, although the shot “A21” is located above the shot “A22” in FIG. 3, the shot “A21” is a shot later than the shot “A22” in time series in FIG. 4. In this manner, the location of each of the shots in a tree shown in FIG. 3 is determined by just the similarity between the shots, but is irrelevant to the appearance order of the shots inside of the picture.

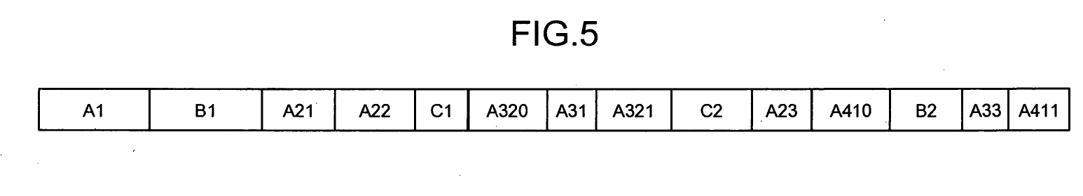

Besides the similarity between the shots, the shot may be structured also in some consideration of the time series (i.e., the appearance order of the shots inside of the picture). The shots such structured as shown in FIG. 3, for example, are assumed to be arranged inside of the picture in such an order as shown in FIG. 5. In this case, the shot “A21” is located before the shot “A31” in both of FIGS. 3 and 5. Specifically, the appearance order of the shots along branches from a root of the tree shown in FIG. 3 accords with the appearance order of the shots inside of the picture (it should be construed that an earlier shot in time series is located at an upper position in the tree). However, the order in time series between the shots in the same hierarchy in the tree is unclear. For example, although the shot “A31” is located above a shot “A320” in FIG.3, the shot “A31” is a shot later than the shot “A320” in time series in FIG. 5. In this manner, when the shot is structured also in consideration of the time series in addition to the similarity, a capacity of a frame memory required for local decoding or decoding can be reduced.

The shot-structuring unit 112 not only classifies and hierarchizes the shots but also selects at least one frame in each of the shots as a representative frame. In FIG. 3, “K_{A1}”, “S_{A21}”, and the like under the shots are representative frames. For example, a frame near a head in the shot “A1” and a frame near middle in the shot “A21” are representative frames, respectively.

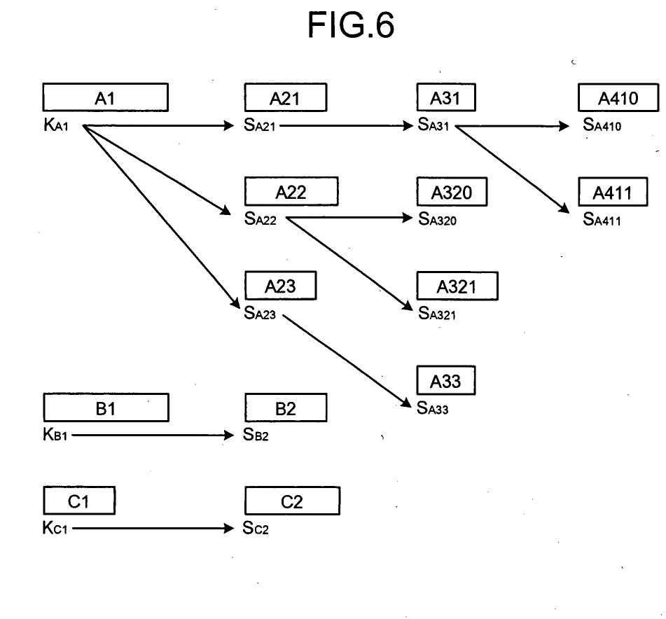

Although the present invention places no particular importance on which frame in the shot is regarded as a representative frame, it is desirable that a frame having as small a difference as possible from other frames in the shot should be a representative frame from the viewpoint of the encoding efficiency (for example, frame k having a minimum sum S=D_{k,a}+D_{k,b}+D_{k,c}+ . . . +D_{k,n} of the similarities of other frames in the shot). For more simplicity, a head frame of each of the shots may be selected as a representative frame all the time, as shown in, for example, FIG. 6.

According to the present invention, a representative frame in the shot located on the root of the tree in each of the groups is referred to as “a key frame” and, representative frames in the other shot are referred to as “sub key frames”. The former by itself (that is, in no reference to the other frames) is subjected to intra-encoding and, the latter is subjected to prediction encoding in reference to a key frame or a sub key frame in one and the same group.

The arrow in FIG. 3 signifies a direction of the prediction. In explaining in reference to the group A in FIG. 3, first, a key frame, that is, the representative frame “K_{A1}” in the shot “A1” in the highest hierarchy in the tree is an intra-frame. And then, all of sub key frames “S_{A21}”, “S_{A22}”, and “S_{A23}” as representative frames in the shots “A21”, “A22”, and “A23” in a second hierarchy, that is, the next higher hierarchy are encoded (i.e., a difference from the frame “K_{A1}” is encoded) in reference to the frame “K_{A1}”. Thereafter, sub key frames “S_{A31}”, “S_{A320}”, “S_{A321}”, and “S_{A33}” as representative frames in the shots “A31”, “A320”, “A321”, and “A33” in a third hierarchy, that is, the further next higher hierarchy are encoded in reference to the sub key frames “S_{A21}”, “S_{A22}”, “S_{A22}”, and “S_{A23}”, respectively. Finally, both of sub key frames “S_{A410}” and “S_{A411}” as representative frames in the shots “A410” and “A411” in a fourth hierarchy, that is, the still further next higher hierarchy are encoded in reference to the sub key frame “S_{A31}”.

Incidentally, a frame other than the representative frame such as the key frame or the sub key frame is referred to as “a normal frame”. Such a normal frame may refer to a frame in the same manner in the conventional JPEG or MPEG. Here, the normal frame refers to a representative frame in the shot, to which the normal frame belongs, all the time (it may be construed that in the normal frame, a key frame or a sub key frame in one and the same shot is subjected to the prediction encoding). In this case, only key frames, specifically, “K_{A1}”, “K_{B1}”, and “K_{C1}”, in the groups shown in FIG. 3, respectively, are intra-frames. In addition, even the sub key frame or the normal frame selectively refers to a frame similar to itself, thereby enhancing the prediction efficiency, so as to reduce data production amount (i.e., increase in compression rate) or improve the quality of an image in the case of the same production amount. Furthermore, random accessibility is enhanced in comparison with the case where the data amount is reduced by, for example, prolonging an interval between the intra-frames.

While the reference frame is selected on the basis of the similarity, there is a possibility that no locally decoded image of the reference frame is stored in the locally-decoded-image storage memory 107 shown in FIG. 1 when the frame to be encoded is to be encoded since the reference frame is not always located near the frame to be encoded (that is, in a predetermined distance from the frame to be encoded) according to the present invention. In view of this, a reference-frame storage memory 113, as shown in FIG. 1, is provided according to the present invention, and thus, locally decoded images of frames, which are possibly referred to by the other frames (specifically, the key frame or the sub key frame), are stored in the reference-frame-storage memory 113. In FIG. 1, the locally-decoded-image storage memory 107 and the reference-frame storage memory 113 are memories independent of each other. This, however, is a conceptual independence, and therefore, the memories 107 and 113 may actually consist of a single memory.

In the meantime, the shot structuring unit 112 holds the structure between the shots, which is schematically and conceptually shown in FIG. 3 or FIG. 6, as “structured information”. The structured information specifically includes frame position information as to where in the input buffer memory 100 the frames in the picture are stored, reference frame selection information as to which frame refers to which frame, and the like. Here, the structured information may be stored in not the shot structuring unit 112 but the input buffer memory 100, and then, may be sequentially read from the shot structuring unit 112. Otherwise, the frames may be arranged in an arbitrary order (i.e., an arbitrary physical arrangement order) in the input buffer memory 100.

The shot structuring unit 112 outputs the frames stored in the input buffer memory 100 in sequence in the encoding order specified by the reference frame selection information (a frame referring to another frame can be encoded only after the reference frame is encoded). At this time, when the output frame to be encoded is the sub key frame or the normal frame, the reference-frame storage memory 113 is instructed to output the key frame or the sub key frame as the reference frame of the output frame to be encoded (i.e., a previously encoded and locally decoded frame) to the motion-vector detecting unit 108 and the inter-frame-motion compensating unit 109.

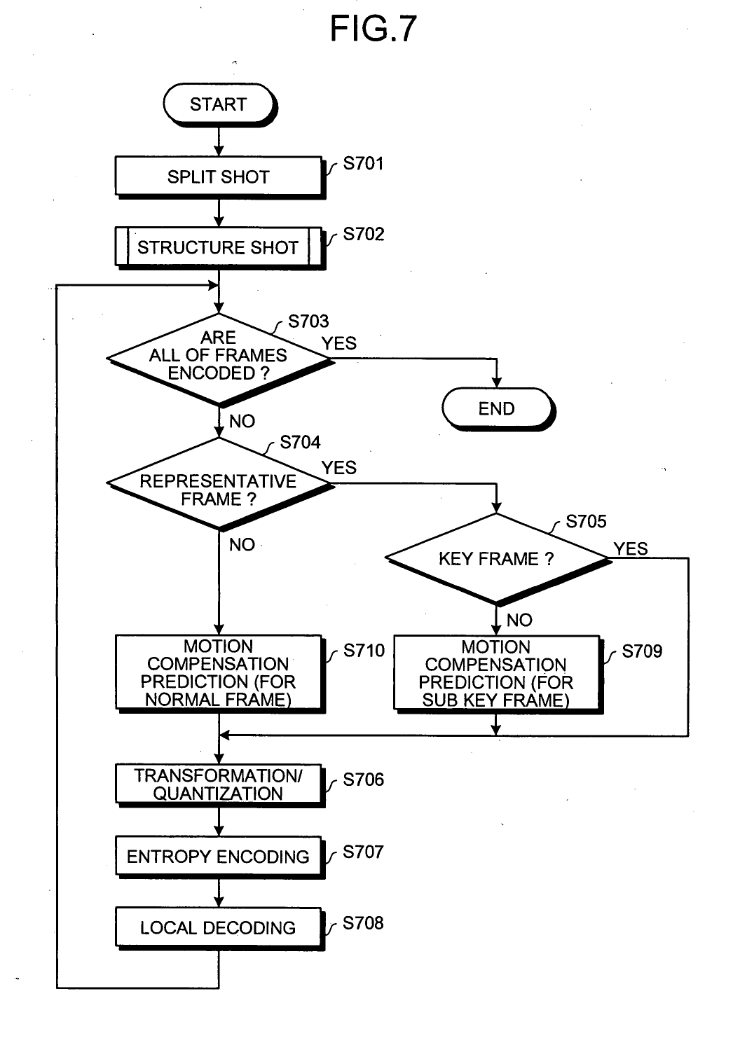

FIG. 7 is a flowchart of image encoding processing procedures in the image processing device according to an embodiment of the present invention. First, the shot splitting unit 111 splits a picture stored in the input buffer memory 100 into plural shots (step S701), and then, the shot structuring unit 112 structures the shots on the basis of the similarity between the shots (step S702).

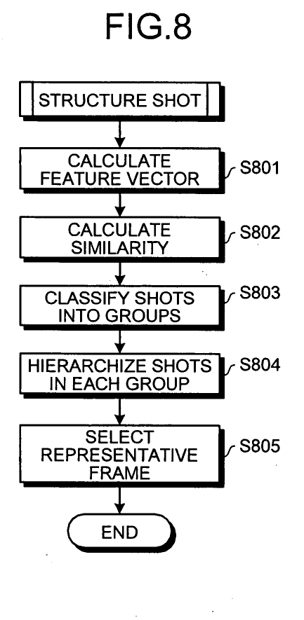

FIG. 8 is a flowchart of the details of a shot structuring procedure in the shot-structuring unit 112 (step S702 in FIG. 7). As described above, the shot-structuring unit 112 calculates a feature vector of each of the shots (step S801), and then, calculates a distance between the feature vectors, that is, a similarity between the shots (step S802). On the basis of the similarity, the shot structuring unit 112 classifies the shots into plural groups (step S803), and further, links the shots having a remarkably high similarity in each of the groups to each other, thus hierarchizing the shots, as shown in FIG. 3 or FIG. 6 (step S804). Thereafter, the shot-structuring unit 112 selects the representative frame of each of the shots (step S805).

Returning to the explanation in reference to FIG. 7, after the shot in the picture is structured according to the procedures, the processing at steps S703 to S710 is repeated with respect to each of the frames in the apparatus as long as there is an unprocessed frame in the input buffer memory 100 (NO at step S703). Specifically, when the frame to be encoded output from the input buffer memory 100 is the representative frame, and further, is the key frame (YES at step S704 and YES at step S705), the frame is transformed and quantized in the transforming unit 101 and the quantizing unit 102, respectively (step S706), and then encoded in the entropy encoding unit 103 (step S707). In the meantime, the transformed and quantized data is locally decoded (i.e., is inversely quantized and inversely transformed) in the inverse quantizing unit 105 and the inverse transforming unit 106, respectively (step S708), and thus stored in the locally-decoded-image storage memory 107 and the reference-frame storage memory 113.

Alternatively, when the frame to be encoded output from the input buffer memory 100 is the representative frame, and further, is the sub key frame (YES at step S704 and NO at step S705), the motion-vector detecting unit 108 first calculates a motion vector between the frame to be encoded received from the input buffer memory 100 and the reference frame received from the reference-frame storage memory 113 (specifically, the key frame in the group, to which the frame to be encoded belongs). Subsequently, the inter-frame-motion compensating unit 109 performs a motion compensation prediction (step S709), and only the difference from the reference frame is transformed and quantized (step S706) and entropy encoded (step S707). Moreover, the inverse quantizing unit 105 and the inverse transforming unit 106 locally decode (i.e., inversely quantizes and inversely transforms) the transformed and quantized data (step S708). Finally, the data is added with the previously subtracted reference frame, and stored in the locally-decoded-image storage memory 107 and the reference-frame storage memory 113.

Otherwise, when the frame to be encoded output from the input buffer memory 100 is the normal frame (NO at step S704), the motion compensation prediction using the reference frame stored in the reference-frame storage memory 113 (specifically, the key frame or the sub key frame in the shot, to which the frame to be encoded belongs) is performed in the same manner (step S710), and then, only the difference from the reference frame is transformed and quantized (step S706) and entropy encoded (step S707). Moreover, the inverse quantizing unit 105 and the inverse transforming unit 106 locally decode (i.e., inversely quantizes and inversely transforms) the transformed and quantized data (step S708). Thereafter, the data is added with the previously subtracted reference frame, and stored in the locally-decoded-image storage memory 107 and the reference-frame storage memory 113. Upon completion of the processing at steps S704 to S710 with respect to all of the frames in the target picture, the processing shown in the flowchart of FIG. 7 ends (YES at step S703).

Incidentally, in the motion compensation prediction for the normal frame (step S710), the processing amount can be reduced by using a motion compensation prediction of a simply parallel displacement adopted in MPEG-1 or MPEG-2. In contrast, in the motion compensation prediction for the sub key frame (step S709), the number of sub key frames is smaller than that of other frames, and therefore, the somewhat great processing amount can be ignored. Thus, the encoded data amount can be effectively reduced by using affine transformation, which is adopted in MPEG-4, in such a manner that an image can be expressed in scaling, rotation and the like. The present invention places no prime importance on the technique of the motion compensation prediction (and further, requires no change in manner between the normal frame and the sub key frame). The technique of the motion compensation prediction falls roughly into two techniques below. Although the technique (1) is adopted here, it is to be understood that the technique (2) may be adopted.

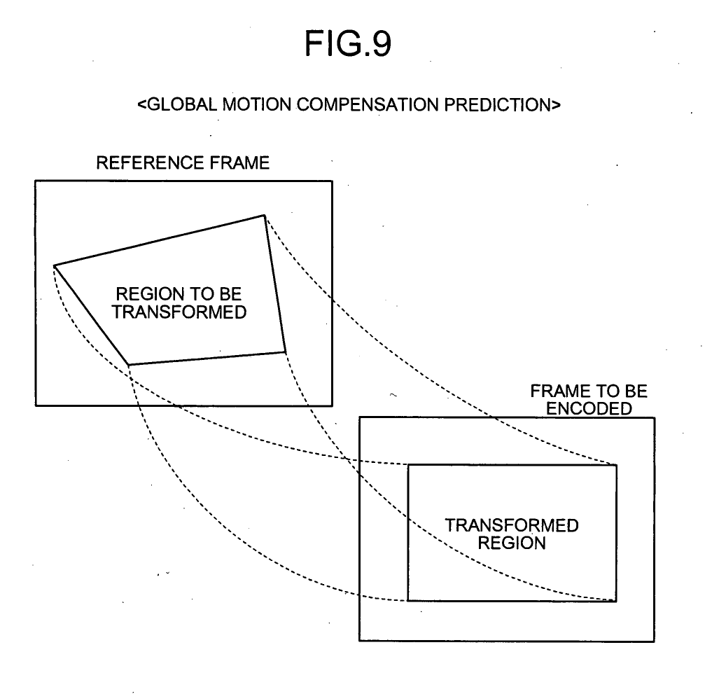

(1) Global Motion Compensation Prediction (FIG. 9)

In this technique, a quadrilateral region inside of a reference frame is warped to a rectangular region in a frame to be encoded (by parallel displacement, scaling, rotation, affine transformation, perspective transform and the like). Specific examples include “Sprite decoding”, in Chapter 7.8 in MPEG-4 (ISO/IEC 14496-2). This global motion compensation prediction enables the motion of the entire frame to be grasped and misalignment or deformation of an object inside of the frame to be corrected.

(2) Motion Compensation Prediction Per Block (FIG. 10)

In this technique, a frame to be encoded is split into square grid blocks, and then, each of the blocks is warped in the same manner as in the technique (1). In the case of parallel displacement as one example of the warping, a region having a smallest error inside of a reference frame is searched per block, and thereafter, misalignment between each of the blocks in the frame to be encoded and each of the searched regions in the reference frame is transmitted as motion vector information. The size of the block is 16×16 pixels (referred to as “a macro block”) in MPEG-1 or MPEG-2. Otherwise, a small block such as 8×8 pixels in MPEG-4 or 4×4 pixels in H.264 may be allowed. Incidentally, the reference frame is not limited to one, and therefore, an optimum region may be selected from plural reference frames. In this case, reference-frame selection information (a number or ID of a reference frame) also need be transmitted in addition to the motion vector information. The local motion of an object inside of the frame can be coped with by the motion prediction per block.

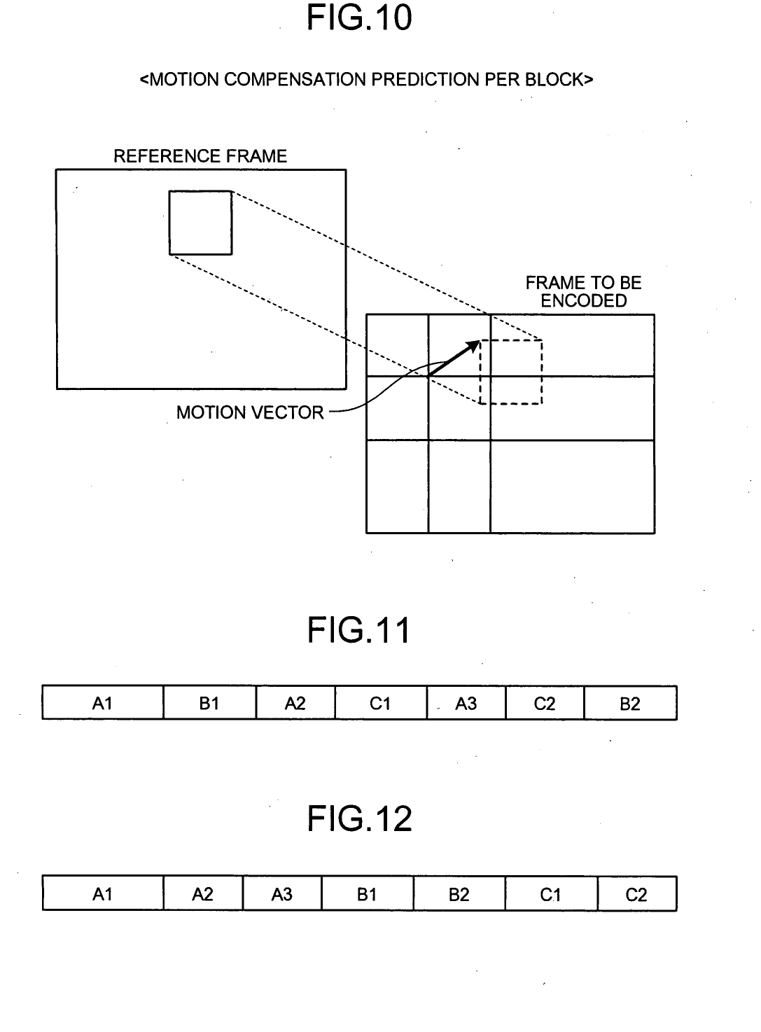

Although the shots in the picture are classified into the similar groups, then to be further hierarchized in each of the groups in the embodiment, only the classification may be performed but the hierarchization may be omitted. In this case, the shot structuring is equivalent to rearranging the shots arranged in the picture as shown in FIG. 11, per group, in an order as shown in FIG. 12. Thus, the frame can be encoded simply by the conventional technique such as MPEG-2. Since transfer to another group is accompanied with a great scene change, an I frame is set only at that point (specifically, the head frame of “A1”, “B1”, or “C1”) and the shot is compressed using only P frames, or P frames and B frames at other points. In this manner, the I frame having large data amount can be remarkably reduced. Incidentally, shot rearrangement information may be stored in user data of MPEG-2, or in data on an application level outside of a code of MPEG-2.

Although the shots are structured per frame in the embodiment, the prediction efficiency can be more enhanced by subdivisibly referring to a similar frame per area or object in the frame.

A large-capacity memory capable of holding therein all of the frames in the picture is needed as the input buffer memory 100 (for example, a frame memory for 2 hours is needed to encode the contents for 2 hours) in the embodiment. However, as the size of a unit to be structured becomes smaller, a memory capacity also becomes smaller by the reduced size. A capacity of a high-speed hard disk capable of reading/writing a moving image at real time is sufficient at present, and thus, can be handled in the same manner as a memory.

When a picture recorded in a storage medium such as a hard disk drive (a hard disk recorder) or a tape drive (a tape recorder: VTR) is encoded, the picture is not encoded at real time but is subjected to so-called multi-pass encoding such as 2-pass encoding, thereby dispensing with a large-capacity memory, with a realistic result. Specifically, at a first pass, the entire contents are examined and a shot is split and structured, and then, only the result (i.e., structured information) is stored in a memory. At a second pass, each of the frames may be read from the storage medium according to the information.

As described above, the present invention is suitable for the picture encoding in a field in which the picture can be encoded at the multi-pass, that is, an encoding delay is of no importance. Applicable examples include picture encoding of a distribution medium (such as a next-generation optical disk) and trans-coding of contents stored in the storage medium (such as data amount compression and movement to a memory card). In addition, the present invention is applicable to picture encoding for broadband streaming or broadcasting a recorded (i.e., encoded) program.

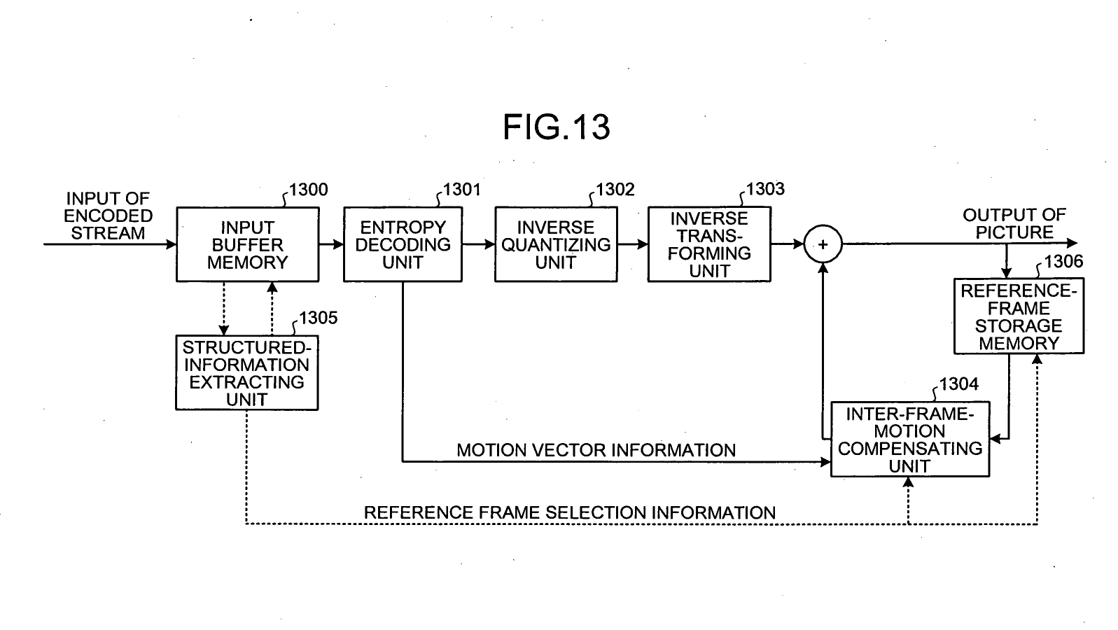

Next, FIG. 13 is an explanatory diagram of one example of the configuration of an image processing device (i.e., a decoder) according to an embodiment of the present invention. The encoder shown in FIG. 1 is paired with a decoder shown in FIG. 13. The picture encoded by the encoder shown in FIG. 1 is decoded by the decoder shown in FIG. 13.

In FIG. 13, the functions of an input buffer memory 1300, an entropy decoding unit 1301, an inverse quantizing unit 1302, an inverse transforming unit 1303, and an inter-frame motion compensating unit 1304 are identical to those in a JPEG/MPEG decoder in the conventional technique.

Reference numeral 1305 designates a structured-information extracting unit that extracts the structured information from encoded streams stored in the input buffer memory 1300. Reference-frame selection information and frame position information included in the structured information extracted here are used to specify a reference frame for a frame to be decoded in the inter-frame-motion compensating unit 1304 in a latter stage and an address of a frame to be output from the input buffer memory 1300, respectively. Moreover, reference numeral 1306 denotes a reference-frame storage memory that holds therein reference frames (specifically, a key frame and a sub key frame) to be used for motion compensation in the inter-frame-motion compensating unit 1304.

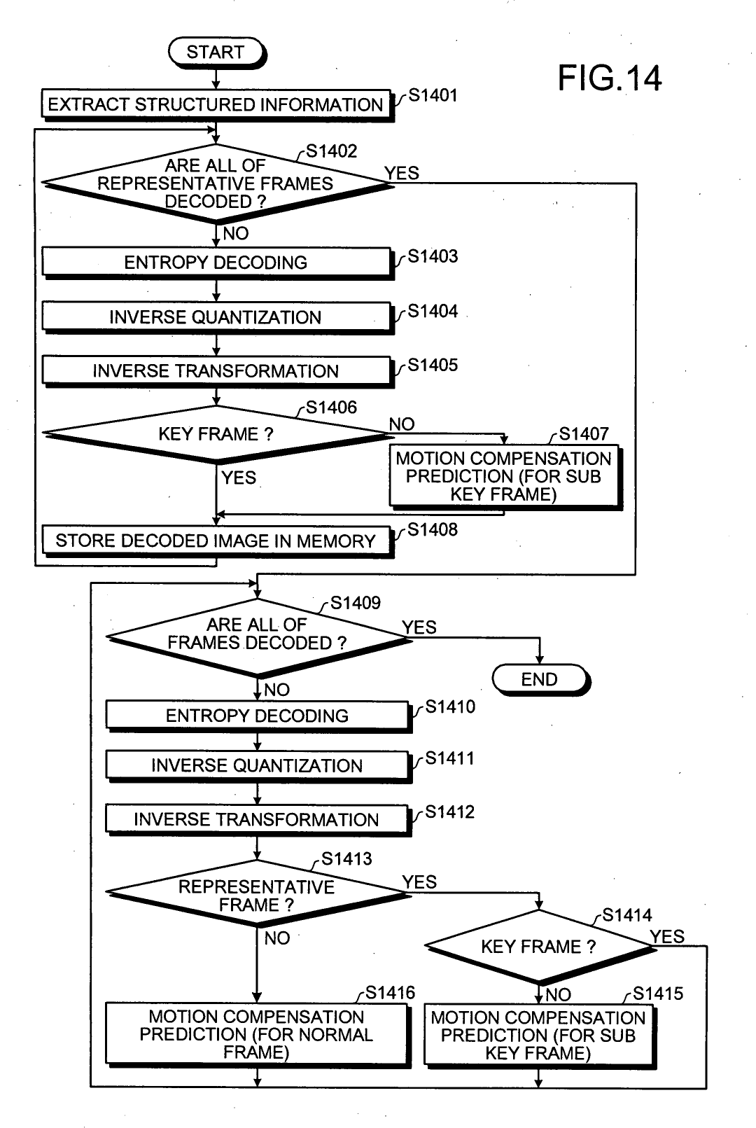

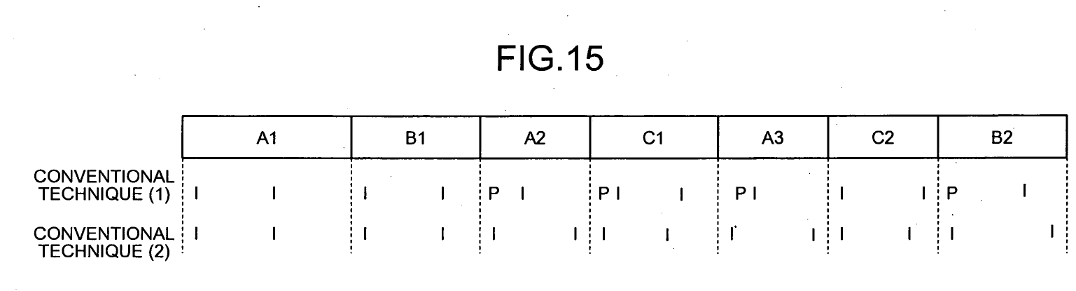

FIG. 14 is a flowchart of image decoding processing procedures in the image processing device according to the embodiment of the present invention. First, the structured-information extracting unit 1305 extracts the structured information from the encoded stream stored in the input buffer memory 1300 (step S1401). Here, the structured information is multiplexed with another encoded stream, and separated from the stream during decoding. However it may not be multiplexed, but be transmitted as independent streams. Moreover, although the configuration of the encoded stream is arbitrary, the structured information and a representative frame (to which another frame refers) are transmitted at, for example, a head of the encoded stream.

The representative frames are first decoded by the entropy decoding unit 1301 (step S1403), are inversely quantized by the inverse quantizing unit 1302 (step S1404), and then, are inversely transformed by the inverse transforming unit 1303 (step S1405). Here, if a frame to be decoded is a key frame (YES at step S1406), the obtained decoded image is stored as it is in the reference frame storage memory 1306 (step S1408), and if the frame to be decoded is not a key frame but a sub key frame (NO at step S1406), the obtained decoded image is stored in the reference-frame storage memory 1306 (step S1408) after a motion compensation prediction for the sub key frame (step S1407).

Upon completion of decoding the representative frames (YES at step S1402), the frame is taken out in output order as long as there is an unprocessed frame in the input buffer memory 1300 (NO at step S1409), decoded by the entropy decoding unit 1301 (step S1410), inversely quantized by the inverse quantizing unit 1302 (step S1411), and inversely transformed by the inverse transforming unit 1303 (step S1412).

Subsequently, if the frame to be decoded is the key frame (YES at step S1413 and YES at step S1414), the obtained decoded image is output as it is, and if the frame to be decoded is the sub key frame (YES at step S1413 and NO at step S1414), the obtained decoded image is output after the motion compensation prediction for the sub key frame (step S1415) or after the motion compensation prediction for a normal frame (NO at step S1413 and step S1416). Thereafter, upon completion of the processing at steps S1410 to S1416 with respect to all of the frames in the encoded stream, the processing shown in the flowchart of FIG. 14 ends (YES at step S1409).

In this manner, since the frames, to which the other frames refer, are collectively decoded in the present embodiment, it is unnecessary to particularly provide any buffer memory for storing the decoded images therein, as shown in FIG. 13 (only the reference-frame storage memory 1306 can sufficiently function also as a buffer memory). Additionally, if the encoded stream is directly read by a random access from a recording medium such as a hard disk in place of the input buffer memory 1300, the capacity of the input buffer memory 1300 is satisfactorily small with a realistic result. It is to be understood that other configurations should be used.

Incidentally, although the representative frame is dually decoded in the flowchart of FIG. 14, it is to be understood that the decoding in the latter stage should be omitted (in other words, the decoded image stored in the reference-frame storage memory 1306 by the decoding in the former stage may be output as it is in the latter stage).

In this manner, according to the inventions of claims 1, 6, and 11, only one intra-frame is contained in the similar shot by noting the similarity (the redundancy of the information) between the plural shots constituting the picture to be encoded, and the other frames are subjected to the prediction encoding using the similar reference frame, thereby suppressing the data amount of the encoded stream. Furthermore, according to the inventions of claims 2, 7, and 12, the reference frame is always selected from the former frames in time sequence (in no reference to the later frames in time sequence), thereby reducing the memory required for the local decoding or the decoding. Moreover, according to the inventions of claims 3, 8, and 13, the reference frame is selected from the shots having the highest similarity among the similar shots, thus enhancing the prediction efficiency accordingly. Additionally, according to the inventions of claims 4, 5, 9, 10, 14, and 15, the picture efficiently encoded by utilizing the similarity between the shots can be decoded according to the inventions of claims 1, 6, and 11.

Incidentally, the image processing method explained in the present embodiment can be achieved by implementing a previously prepared program in an arithmetic processing apparatus such as a processor or a microcomputer. Such a program is recorded in a recording medium readable by the arithmetic processing apparatus, such as a ROM, an HD, an FD, a CD-ROM, a CD-R, a CD-RW, an MO, or a DVD, and then, is read from the recording medium by the arithmetic processing apparatus, and executed. In addition, the program may be a transmission medium, which can be distributed via a network such as the Internet.

1-15. (canceled)

16. An image processing device that encodes a moving image including a plurality of frames to be encoded, the image processing device comprising:
a splitting unit that splits the moving image into a plurality of shots;
a structuring unit that structures, based on a similarity between the shots, the shots into a plurality of groups each of which has a tree-structure, and selects a plurality of representative frames from the shots;
a detecting unit that detects motion information between a target frame and one of the representative frames;
a compensating unit that generates a prediction frame of the target frame based on the motion information; and
an encoding unit that encodes a difference between the target frame and the prediction frame.

17. The image processing device according to claim 16, wherein the structuring unit hierarchically arranges shots in each of the groups in an appearance order of the shots in the moving image.

18. The image processing device according to claim 16, wherein the detecting unit detects, when the target frame is not any one of the representative frames, the motion information between the target frame and one of the representative frames that is included in a shot to which the target frame belongs.

19. The image processing device according to claim 16, wherein the representative frames includes key frames and sub-key frames, and the detecting unit detects, when the target frame is any one of the sub-key frames, the motion information between the target frame and one of the key frames that is included in a group to which the target frame belongs.

20. The image processing device according to claim 19, wherein the encoding unit encodes the target frame when the target frame is any one of the key-frames.

21. An image processing device that decodes an encoded stream including a plurality of frames to obtain a moving image that is split into a plurality of shots and structured into a plurality of groups, each of which has a tree-structure, based on a similarity between the shots, the image processing device comprising:
an extracting unit that extracts information on the tree-structure from the encoded stream;
a first decoding unit that decodes a plurality of representative frames among the frames based on the information; and
a second decoding unit that decodes each of a plurality of normal frames using one of the representative frames that is specified in the information.

22. The image processing device according to claim 21, wherein, each of the representative frames is specified for each of the shots in the information based on a similarity between frames included in each of the shots.

23. An image processing method of encoding a moving image including a plurality of frames to be encoded, the image processing method comprising:
splitting the moving image into a plurality of shots;
structuring, based on a similarity between the shots, the shots into a plurality of groups each of which has a tree-structure;
selecting a plurality of representative frames from the shots;
detecting motion information between a target frame and one of the representative frames;
generating a prediction frame of the target frame based on the motion information; and
encoding a difference between the target frame and the prediction frame.

24. The image processing method according to claim 23, wherein the structuring includes arranging shots in each of the groups in an appearance order of the shots in the moving image.

25. The image processing method according to claim 23, wherein the detecting includes detecting, when the target frame is not any one of the representative frames, the motion information between the target frame and one of representative frames that is included in a shot to which the target frame belongs.

26. The image processing method according to claim 23, wherein the representative frames includes key frames and sub-key frames, and the detecting includes detecting, when the target frame is any one of the sub-key frames, the motion information between the target frame and one of the key frames that is included in a group to which the target frame belongs.

27. The image processing method according to claim 26, wherein the encoding includes encoding the target frame when the target frame is any one of the key-frames.

28. An image processing method of decoding an encoded stream including a plurality of frames to obtain a moving image that is split into a plurality of shots and structured into a plurality of groups, each of which has a tree-structure, based on a similarity between the shots, the image processing device comprising:
extracting information on the tree-structure from the encoded stream;
decoding a plurality of representative frames among the frames based on the information; and
decoding each of a plurality of normal frames using one of the representative frames that is specified in the information.

29. The image processing method according to claim 28, wherein each of the representative frames is specified for each of the shots in the information based on a similarity between frames included in each of the shots.

30. A computer-readable recording medium that stores therein an image processing program for encoding a moving image including a plurality of frames to be encoded, the image processing program causes a computer to execute:
splitting the moving image into a plurality of shots;
structuring, based on a similarity between the shots, the shots into a plurality of groups each of which has a tree-structure;
selecting a plurality of representative frames from the shots;
detecting motion information between a target frame and one of the representative frames;
generating a prediction frame of the target frame based on the motion information; and
encoding a difference between the target frame and the prediction frame.

31. The computer-readable recording medium according to claim 30, wherein the structuring includes arranging shots in each of the groups in an appearance order of the shots in the moving image.

32. The computer-readable recording medium according to claim 30, wherein the detecting unit detects, when the target frame is not any one of the representative frames, the motion information between the target frame and one of the representative frames that is included in a shot to which the target frame belongs.

33. The computer-readable recording medium according to claim 30, wherein the representative frames includes key frames and sub-key frames, and the detecting includes detecting, when the target frame is any one of the sub-key frames, the motion information between the target frame and one of the key frames that is included in a group to which the target frame belongs.

34. The computer-readable recording medium according to claim 33, wherein the encoding includes encoding the target frame when the target frame is any one of the key-frames.

35. A computer-readable recording medium that stores therein an image processing program for decoding an encoded stream including a plurality of frames to obtain a moving image that is split into a plurality of shots and structured into a plurality of groups, each of which has a tree-structure, based on a similarity between the shots, the image processing program causes a computer to execute:
extracting information on the tree-structure from the encoded stream;
decoding a plurality of representative frames among the frames based on the information; and
decoding each of a plurality of normal frames using one of the representative frames that is specified in the information.

36. The computer-readable recording medium according to claim 35, wherein each of the representative frames is specified for each of the shots based on a similarity between frames included in each of the shots.
